(19) United States
(12) Patent Application Publication
(10) Pub. No.: US 2013/0062920 A1
(43) Pub. Date: Mar. 14, 2013

(54) CHAIR WITH INFLATABLE BLADDER SYSTEM

(71) Applicant: Ron McDiarmid, La Habra, CA (US)

(72) Inventor: Ron McDiarmid, La Habra, CA (US)

(21) Appl. No.: 13/232,365

(22) Filed: Sep. 14, 2011

(51) Int. Cl. A47C 4/54; B60B 33/00; A47C 7/00

(52) U.S. Cl. 297/284.6; 248/688; 16/18 R

(57) ABSTRACT

An improved office chair, having an inflatable seat bladder and seat-support coils, and an inflatable lumbar back bladder wherein each bladder is independently inflatable and independently deflatable to the user's desired firmness, through a dedicated inflation mechanism for each bladder, comprising a battery-powered air pump and a check valve, and a dedicated deflation mechanism for each bladder, comprising a battery-powered solenoid valve, wherein each inflation mechanism and deflation mechanism is battery-powered through an onboard battery pack and controlled by the user's manipulation of switches in an onboard control panel.

### FIELD OF THE INVENTION

The present invention relates to the field of chairs, and more specifically to the field of ergonomic office chairs.

### BRIEF SUMMARY OF THE INVENTION

The present invention is an office chair with an inflatable bladder located in the lumbar portion of the seat back, and an inflatable bladder in the forward seat portion of the chair, in combination with coil support in the rear seat portion of the chair, each bladder with an independently-controlled inflation mechanism and an independently-controlled deflation mechanism to inflate and deflate the bladder. External controls which are accessible to the chair's occupant are provided for the inflation and deflation mechanisms of the bladders, and the controls allow the chair's occupant to adjust the firmness of the bladder in the seat and the bladder in the lumbar portion of the chair, so that each is at the occupant's desired setting by inflating or deflating each bladder independently of the other. The control panel and the inflation and deflation mechanisms are battery-powered, so that the chair does not require any connection to a stationary wall source of electrical power.

### BRIEF DESCRIPTION OF THE DRAWINGS

FIG. 1 is a top perspective view of an embodiment of the office chair, including a representation of the valve system in fluid connection with the inflatable bladders;

FIG. 2 is an exploded top perspective of the office chair, showing the primary portions of the chair separated;

FIG. 3 is a bottom perspective view of the control panel, located on the bottom side of the seat;

FIG. 4 is a diagram showing the pneumatic and electrical system controlling the inflation and deflation system for each inflatable bladder; and

FIG. 5 is a top plan view of the lumbar bladder and seat bladder.

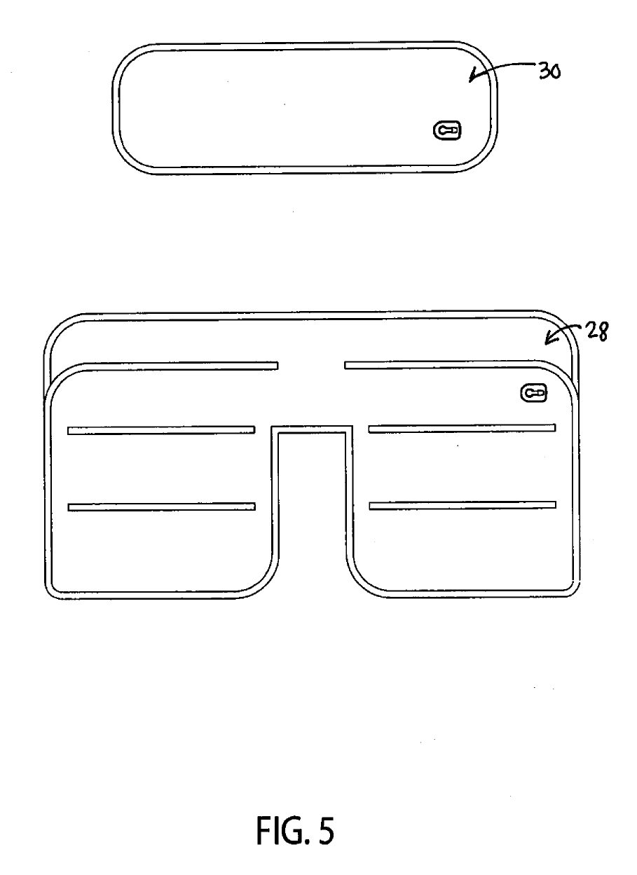

### DESCRIPTION OF THE PREFERRED EMBODIMENTS

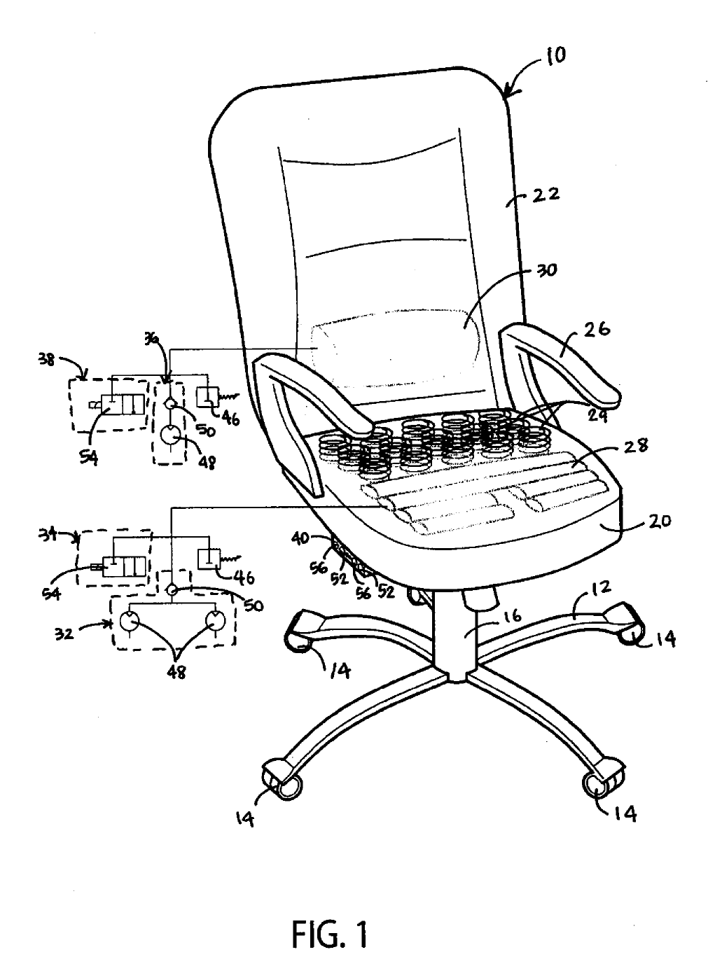

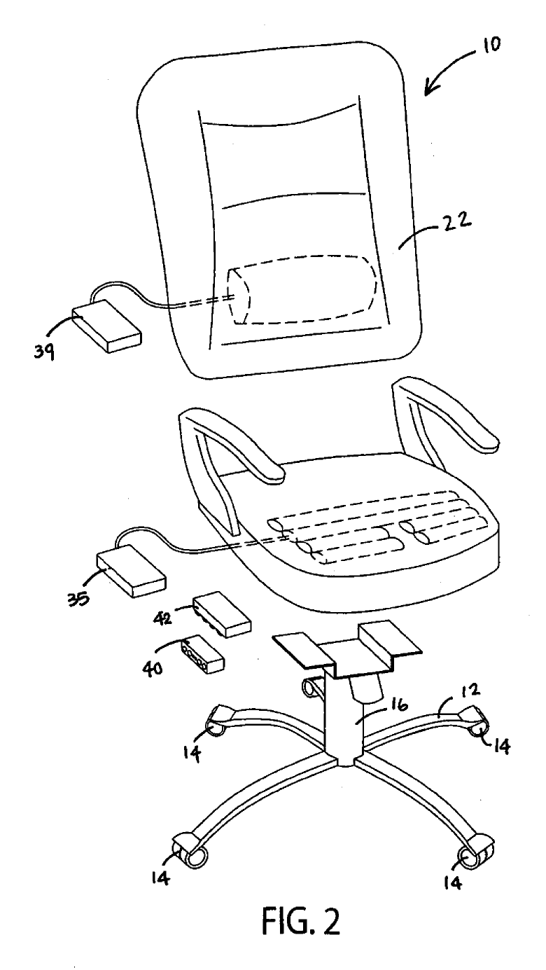

In one preferred embodiment, the office chair 10 comprises a base 12, such as a five-star base 12, preferably fitted with casters 14 for mobility, a pedestal 16 extending upward from the base 12 and optionally incorporating a gas lift height adjustment 18, a seat pan 20 attached to the top of the pedestal 16, and a seat back 22 extending upwards from the back edge of the seat pan 20 at an angle that is adjustable using a tilt mechanism 24. The office chair may also include arms 26. (FIG. 1, FIG. 2.)

An inflatable seat bladder 28 is integrated into the top side of the seat 20, on the forward portion thereof, such that it will be positioned below an occupant's legs when an occupant is seated in the chair 10, and an inflatable back bladder 30 is provided in the lower portion of the seat back 22 such that it would support the lumbar region of the chair occupant's back. The rear portion of seat 20 further comprises coil supports 29 for the occupant's buttocks when the occupant is seated in the chair. The inflatable seat bladder 28 and back bladder 30 are contoured, as well as coil supports 29, so as to provide an ergonomic seat for the occupant, and bladders 28, 30 are also preferably contoured to provide increased strength to the bladders 28, 30.

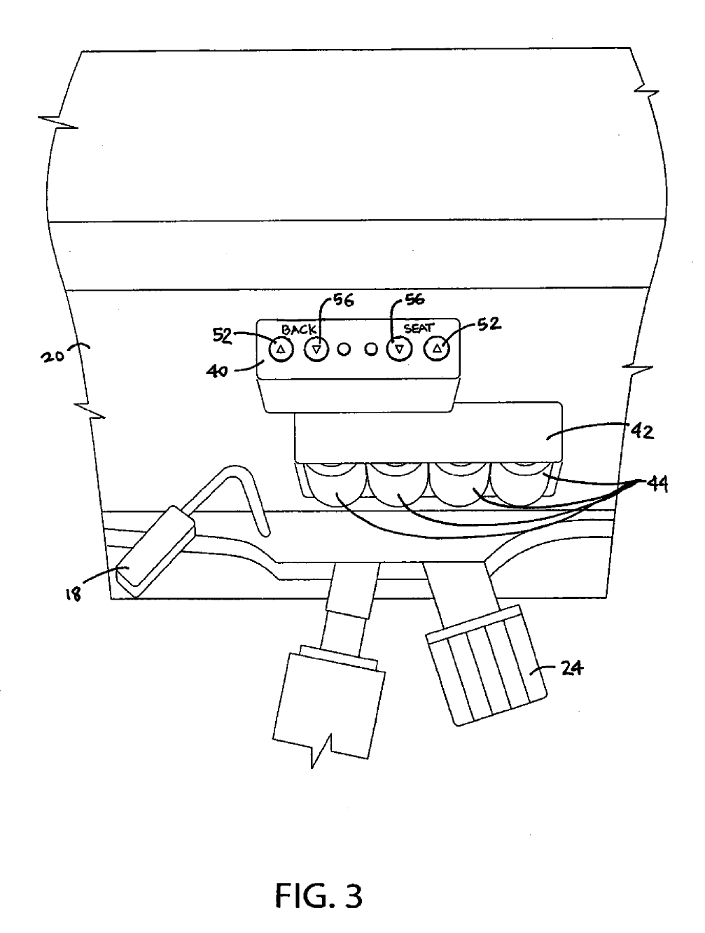

The inflatable seat bladder 28 has an independent inflation mechanism 32 and an independent deflation mechanism 34, both of which are preferably housed in a seat bladder control housing 35, and the inflatable back bladder 30 has an independent inflation mechanism 36 and an independent deflation mechanism 38 both of which are preferably housed in a back bladder control housing 39. Each inflation mechanism 32, 36 and each deflation mechanism 34, 38 is independently controlled via a control panel 40 which is electrically connected to each of the inflation mechanisms 32, 36 and each of the deflation mechanisms 34, 38 and is in a location accessible to the chair's occupant, preferably in a location on the bottom of the seat pan 20 near the controls for the other chair adjustment features, such as the gas lift 18 and the tilt mechanism 24. To power the control panel 40, and the inflation mechanisms 32, 36 and deflation mechanisms 34, 38, a battery housing 42 to securely hold a battery 44 or set of batteries 44 is provided, and the batteries 44 are electrically connected to the housing 42 and the housing 42 is electrically connected to the control panel 40, and the housing 42 is also preferably located on the underside of the seat pan 20. (FIG. 3). Each bladder 28, 30 also has its own independent overpressure release valve 46, which protects the bladder 28, 30 from over-filling by the occupant and from increased pressure due to a heavier occupant sitting in the chair. (FIG. 1).

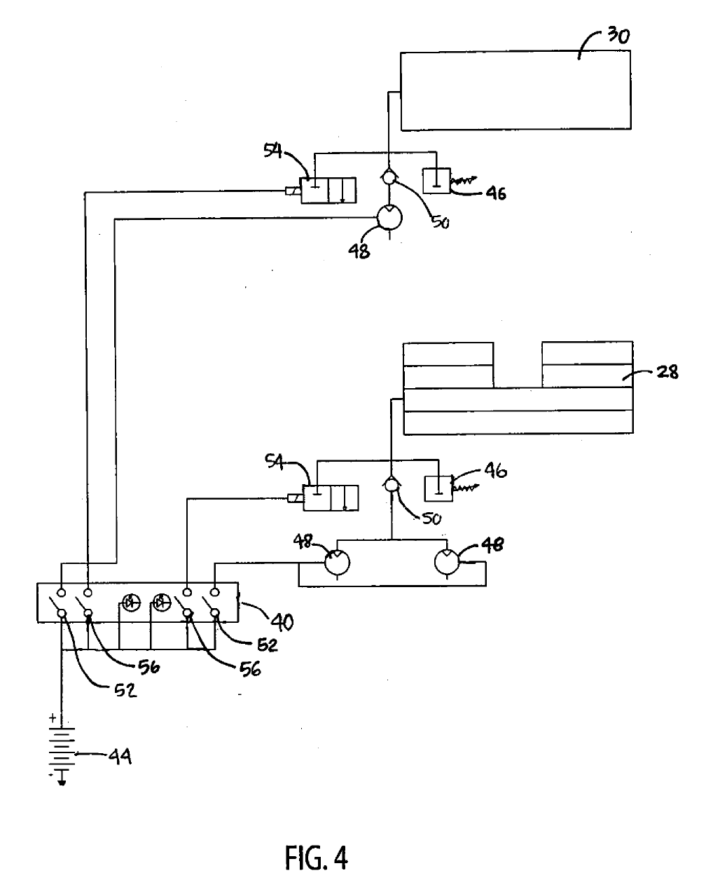

The inflation mechanism 32, 36 for each bladder 28, 30 preferably comprises at least one battery-powered air pump 48 and a check valve 50, which are in fluid connection with the air in the inflatable bladder 28, 30, where the check valve 50 allows the air to travel from the pump 48 toward the inflatable bladder 28, 30, but not in the opposite direction. (FIG. 1, FIG. 4) Due to its larger size, it may be preferable to have the seat bladder 28 filled with air at a higher rate than the back bladder 30, which could be accomplished through the use of a larger air pump 48 or through multiple air pumps 48 connected to the inlet of the seat bladder 28 in parallel. (FIG. 1) Preferably, two (2) air pumps 48 are used in parallel to fill the seat bladder 28. Each inflation mechanism 32, 36 is independently controlled by the occupant through the control panel 40 with a switch 52, such that when the switch 52 is located in one position the air pump 48 remains off and the check valve 50 does not allow the escape of air from the relevant bladder 28, 30, and when the switch 52 is located in the other position, the air pump 48 is activated and air is pumped through the check valve 50 and into the relevant bladder 28, 30. (FIG. 4) A separate check valve 50 may not be required if the pump 48 is sufficient to allow only one direction of airflow.

The deflation mechanism 34, 38 for each bladder 28, 30 comprises a battery-powered solenoid valve 54 which is in fluid connection with the air in the relevant bladder 28, 30, and which, when open, allows the air inside the bladder 28, 30 to escape from the bladder 28, 30. (FIG. 1, FIG. 4). Each solenoid valve 54 is independently controlled by the occupant through the control panel 40 with a switch 56, such that when the switch 56 is located in one position, the solenoid valve 54 is opened to allow air to be released from the relevant bladder 28, 30, and when the switch 56 is located in the other position, the solenoid valve 54 is closed and air cannot leave the relevant bladder 28, 30 through the solenoid valve 54. (FIG. 4)

Each bladder 28, 30 is also preferably equipped with an overfill relief valve 46 which can be set to a desired pressure, based on the size, configuration and material used to construct the bladder 28, 30, to ensure that the pressure within the bladder 28, 30 is not increased beyond the capacity of the bladder 28, 30. (FIG. 1, FIG. 4). For example, the relief valve 46 can be set to allow air to bleed out of the bladder 28, 30 when the pressure inside the bladder 28, 30 reaches a pressure of about 2.5 psi to protect the bladder 28, 30 from being damaged.

Of course it is understood that the above is merely a preferred embodiment of the invention, and that various changes and alterations can be made without departing from the spirit and broader aspects thereof.

What is claimed is:

1. An office chair comprising:
a seat support;
a seat pan mounted to the top of the seat support;
a seat back mounted along the back edge of the seat pan;
at least one inflatable seat bladder incorporated into the top side of the seat pan and a plurality of coils supporting the top side of the seat pan;
at least one inflatable back bladder incorporated into the front side of the seat back in the lumbar region of the seat back;
a control panel attached to the chair having a set of manually operable electrical switches, wherein the control panel and the switches are located in a position such that the switches are accessible to a user of the chair;
a battery pack attached to the chair and electrically connected to the control panel;
a seat bladder inflation mechanism in fluid connection with the seat bladder, and a back bladder inflation mechanism in fluid connection with the back bladder, wherein each inflation mechanism is capable of being independently operated by the user and each inflation mechanism comprises at least one air pump which is electrically connected to the battery pack through a switch in the control panel, such that when the switch is in one position, the air pump will pump air into the bladder, and when the switch is in the opposite position, the air pump will not operate to pump air into the bladder; and
a seat bladder deflation mechanism in fluid connection with the seat bladder and a back bladder deflation mechanism in fluid connection with the back bladder, wherein each deflation mechanism is capable of being independently operated by the user and each deflation mechanism comprises a solenoid valve which is electrically connected to the battery pack through a switch in the control panel, such that when the switch is in one position, the solenoid valve will be opened to allow air to escape the bladder and when the switch is in the opposite position, the solenoid valve will be closed and will not allow air to escape the bladder.

2. The office chair of claim 1 wherein the inflation mechanism for the seat bladder further comprises a check valve in fluid connection with the air in the seat bladder and located between the seat bladder and the air pump, to prevent air from re-entering the pump from the seat bladder when the pump is not pumping air; and wherein the inflation mechanism for the back bladder further comprises a check valve in fluid connection with the air in the back bladder and located between the back bladder and the air pump, to prevent air from re-entering the pump from the back bladder when the pump is not pumping air.

3. The office chair of claim 2 wherein the inflation mechanism comprises two or more air pumps fluidly connected in parallel to the seat bladder.

4. The office chair of claim 3 wherein the control panel is located on the bottom side of the seat pan.

5. The office chair of claim 4 wherein said seat support comprises a base and a pedestal mounted to the top of the base.

6. The office chair of claim 5 further comprising a set of casters connected to the base of the office chair to increase the chair's mobility.

7. The office chair of claim 6 further comprising a gas lift mechanism and a tilt mechanism for the office chair to increase the adjustability of the chair.

8. The office chair of claim 1 wherein the inflation mechanism comprises two or more air pumps fluidly connected in parallel to the seat bladder.

9. The office chair of claim 1 wherein the control panel is located on the bottom side of the seat pan.

10. The office chair of claim 1 wherein said seat support comprises a base and a pedestal mounted to the top of the base.

11. The office chair of claim 1 comprising: a release valve in fluid connection with the seat bladder and a release valve in fluid connection with the back bladder, wherein each release valve will allow air to escape from the bladder when the fluid pressure in the bladder exceeds a predetermined pressure threshold.

12. An office chair comprising:
a seat support;
a seat pan mounted to the top of the seat support;
a seat back mounted along the back edge of the seat pan;
at least one inflatable seat bladder incorporated into the top side of the seat pan and a plurality of coils to support the top side of the seat pan;
at least one inflatable back bladder incorporated into the front side of the seat back in the lumbar region of the seat back;
a control panel attached to the chair having a set of manually operable electrical switches, wherein the control panel and the switches are located in a position such that the switches are accessible to a user of the chair;
a battery pack attached to the chair and electrically connected to the control panel;
a seat bladder inflation mechanism in fluid connection with the seat bladder, and a back bladder inflation mechanism in fluid connection with the back bladder, wherein each inflation mechanism is capable of being independently operated by the user and each inflation mechanism comprises at least one air pump which is electrically connected to the battery pack through a switch in the control panel, such that when the switch is in one position, the air pump will pump air into the bladder, and when the switch is in the opposite position, the air pump will not operate to pump air into the bladder;
a seat bladder deflation mechanism in fluid connection with the seat bladder and a back bladder deflation mechanism in fluid connection with the back bladder, wherein each deflation mechanism is capable of being independently operated by the user and each deflation mechanism comprises a solenoid valve which is electrically connected to the battery pack through a switch in the control panel, such that when the switch is in one position, the solenoid valve will be opened to allow air to escape the bladder and when the switch is in the opposite position, the solenoid valve will be closed and will not allow air to escape the bladder; and
said control panel having four switches, wherein one switch operates the seat inflation mechanism, one switch operates the seat deflation mechanism, one switch operates the back inflation mechanism and one switch operates the back deflation mechanism.

13. The office chair of claim 12 wherein the inflation mechanism for the seat bladder further comprises a check valve in fluid connection with the air in the seat bladder and located between the seat bladder and the air pump, to prevent air from re-entering the pump from the seat bladder when the pump is not pumping air; and wherein the inflation mechanism for the back bladder further comprises a check valve in fluid connection with the air in the back bladder and located between the back bladder and the air pump, to prevent air from re-entering the pump from the back bladder when the pump is not pumping air.

14. The office chair of claim 13 wherein the inflation mechanism comprises two or more air pumps fluidly connected to the air in the seat bladder in parallel.

15. The office chair of claim 14 wherein said seat support comprises a base and a pedestal mounted to the top of the base.

16. The office chair of claim 15 further comprising a set of casters connected to the base of the office chair to increase the chairs mobility.

17. The office chair of claim 16 wherein the control panel is located on the bottom side of the seat pan.

18. The office chair of claim 17 further comprising a gas lift mechanism and a tilt mechanism for the office chair to increase the adjustability of the chair.

19. The office chair of claim 12 wherein the inflation mechanism comprises two or more air pumps fluidly connected in parallel to the seat bladder.

20. The office chair of claim 12 wherein the control panel is located on the bottom side of the seat pan.

21. The office chair of claim 12 wherein said seat support comprises a base and a pedestal mounted to the top of the base.

22. The office chair of claim 12 comprising: a release valve in fluid connection with the seat bladder and a release valve in fluid connection with the back bladder, wherein each release valve will allow air to escape from the bladder when the fluid pressure in the bladder exceeds a predetermined pressure threshold.

23. An office chair, comprising:
a seat support;
a seat pan mounted to the top of the seat support, having a top side with a forward portion and a rear portion, and having a back edge;
a seat back mounted along the back edge of the seat pan;
at least one inflatable seat bladder incorporated into the forward portion of the top side of the seat pan;
a plurality of coils to provide support in the rear portion of the top side of the seat pan;
at least one inflatable back bladder incorporated into the front side of the seat back in the lumbar region of the seat back.
